(19) United States
(12) Patent Application Publication
(10) Pub. No.: US 2010/0000511 A1
(43) Pub. Date: Jan. 7, 2010

(54) BARBECUE GRILLING GRATE ASSEMBLY

(76) Inventor: Athanasios Koropoulis, Athens (GR)

Correspondence Address: Carter, DeLuca, Farrell & Schmidt, LLP, 445 Broad Hollow Road - Suite 225, Melville, NY, 11747, US

(21) Appl. No.: 12/168,481

(22) Filed: Jul. 7, 2008

(51) Int. Cl. A47J 37/00

(52) U.S. Cl. 126/25 R

(57) ABSTRACT

A barbecue grilling grate assembly for use in a barbecue grilling system is disclosed. The barbecue grilling grate assembly includes a grilling grate having a plurality of grilling bars and a bordering bar. The grilling grate includes a top surface and a bottom surface. The top surface is configured to allow food to be cooked atop. The bottom surface includes an inlet port defined thereon and is configured to evacuate smoke from a heat source via the inlet port. The grilling bars are fluidly connected to the bordering bar, which both define hollow channels therewithin to allow smoke from a heat source to pass therethrough and out to an outlet port. The grilling grate assembly further includes a tubular structure and a smoke evacuation device, which are selectively attached to the outlet port.

### BACKGROUND

1. Technical Field

The present disclosure relates to the field of barbecue grilling grates. In particular, the present disclosure relates to a grilling grate assembly having an inlet port, an outlet port, and in fluid communication with a smoke evacuation device.

2. Description of Related Art

Generally, barbecue grilling grates are utilized to cook different kinds of foods, for example, meats, vegetables, fish, etc. The common barbecue grilling system includes a box-like housing, which supports a grilling grate assembly with a plurality of slits, so that food may be cooked on a top surface of the grilling grate. A heat source (e.g., gas, charcoal briquettes, etc.) is disposed below, or sometimes above, the grilling grate, which in turn, cooks the food placed on the top surface of the grilling grate.

While the food is being cooked atop the grilling grate, fluids (e.g., barbecue sauce) and debris from the food (e.g., fat juices from meat) fall through the slits of the barbecue grate assembly and onto the charcoal briquettes. The fluid and debris burn on the heat source, thus emitting a harmful smoke and vapor. For example, when fat juices from meat fall onto a burning pile of charcoal briquettes, the fat juices ignite and produce a distinct smoke and vapor. The smoke and vapor from the burned fat juices then rise up from the briquettes and seep into the food being cooked, thus adding unwanted smoke flavors into the food. Studies have shown that smoke from burning fat drippings, along with smoke from burning wood and charcoal, may be cancerous. While there have been developments in barbecue technology designed to veer the juices and debris away from the briquettes, there still exists a need for a device that substantially directs the smoke and vapor emitted from the briquettes away from the food being cooked atop the barbecue grilling grate.

### SUMMARY

A barbecue grilling grate assembly for use in a barbecue grilling system is disclosed. The barbecue grilling grate assembly includes a grilling grate having a plurality of grilling bars and a bordering bar. The grilling grate includes a top surface and a bottom surface. The top surface is configured to allow food to be cooked atop. The bottom surface includes an inlet port defined thereon and is configured to evacuate smoke from a heat source via the inlet port. The grilling bars are fluidly connected to the bordering bar, which both define hollow channels therewithin to allow smoke from a heat source to pass therethrough and out to an outlet port. The grilling grate assembly further includes a tubular structure and a smoke evacuation device, which are selectively attached to the outlet port. The smoke evacuation device is configured to evacuate the smoke entering the grilling grate assembly and force the smoke to an external environment.

In embodiments, the grilling grate is configured to be dimensioned from a group of shapes consisting of rectangular, square, elliptical, and polygonal. The top surface of grilling grate is configured to be coated by a finishing technique selected from the group consisting of a smooth surface, a textured surface, and a TEFLON coated surface.

In addition, the grilling bars are configured to be positioned parallel and equally spaced from each other, the spaces of the grilling bars defining slits. The grilling bars are attached to the bordering bar from an attaching technique selected from the group consisting of welding, gluing, soldering, bonding, and crimping. Alternatively, the grilling grate assembly is constructed by a molding process.

In embodiments, the at least one bordering bar is configured to have a thicker wall than the wall of the at least one grilling bar, the thicker wall adding structural rigidity to the grilling grate. The heat source is energized by a heating technique selected from the group consisting of barbecue briquettes, a heating element, and gas jets. The smoke evacuation device is an exhaust fan mechanism. The smoke evacuation device includes an on/off switch and/or a variable speed switch to allow a user to adjust the rate of smoke and vapor to be evacuated. A filter is configured to cover the at least one inlet port. The inlet ports are configured to be dimensioned by a group of shapes consisting of a circular shape, square shape, rectangular shape, and a polygonal shape.

In another embodiment of the present disclosure, a barbecue grilling system including a barbecue grilling grate assembly is disclosed. The barbecue grilling system includes a lower housing and an upper housing. The grilling grate assembly includes a grilling grate having a plurality of grilling bars fluidly connected to a bordering bar, a top surface, a bottom surface, an outlet port in communication with a tubular structure, and a smoke evacuation device.

The heating element is disposed on the bottom portion of the lower housing. The lower housing includes an inner perimeter edge of the lower housing and is configured and dimensioned to support the grilling grate. The grilling grate assembly is selectively disposed on the inner perimeter edge of the lower housing.

In embodiments, the upper housing is configured to be in an open position and a closed position. The closed position allows a temperature to increase between the top surface and the inner cavity of the upper housing. In addition, the area between the top surface and the inner cavity is defined as a cooking space.

In embodiments, the barbecue grilling system further includes a leg structure to support the lower housing having a plurality of wheels. The wheels allow a user to transport the barbecue grilling system. The barbecue grilling system is configured to have a box-shape configuration.

### BRIEF DESCRIPTION OF THE DRAWINGS

FIG. 1 is a perspective view of a barbecue grilling system having a barbecue grilling grate assembly installed therein, in accordance with the present disclosure;

FIG. 2A is a top perspective view of an embodiment of a barbecue grilling grate assembly shown in FIG. 1;

FIG. 2B is a bottom perspective view of the barbecue grilling grate assembly shown in FIG. 2A;

FIG. 3 is a perspective cross-sectional view of a channel of the barbecue grilling grate assembly of FIG. 2A.

FIG. 4A is a top perspective view of another embodiment of a barbecue grilling grate assembly of the present disclosure;

FIG. 4B is a bottom perspective view of the barbecue grilling grate assembly shown in FIG. 3A;

FIG. 5A is a top perspective view of another embodiment of a barbecue grilling grate assembly of the present disclosure; and

FIG. 5B is a bottom perspective view of still another embodiment of a barbecue grilling grate assembly of the present disclosure.

### DETAILED DESCRIPTION

Particular embodiments of the present disclosure are described hereinbelow with reference to the accompanying drawings. In the following description, well-known functions or constructions are not described in detail to avoid obscuring the present disclosure in unnecessary detail.

In general, the present application discloses a barbecue grilling grate assembly for use on a barbecue housing for grilling food. The barbecue grilling grate assembly generally includes a grilling grate having a plurality of grilling bars, which are fluidly connected to a bordering bar. The grilling grate defines hollow channels (i.e., within the bars) to allow smoke from a heat source to pass therethrough. A top surface of the barbecue grilling grate assembly allows food to be cooked atop and the bottom surface includes a plurality of inlet ports defined therein, which allow smoke to be evacuated via the plurality of inlet ports, as will be discussed in detail below. In addition, the barbecue grilling grate assembly further includes a plurality of outlet ports, a tubular structure and a smoke evacuation device, which evacuate the smoke entering the grilling grate assembly to an external environment, as will also be discussed in detail below.

During use, the food releases juices and debris, which fall and burn on to the heat source to produce harmful smoke and vapors. The smoke evacuation device vacuums the smoke and vapors into the plurality of inlet ports disposed on the bottom surface of the grilling grate. The smoke and vapors are then vacuumed through the channels to a single outlet port or plurality of outlet ports disposed on the side of the bordering bar of the barbecue grilling grate, then through the tubular structure and to an external environment. Thus, allowing substantially all of the harmful smoke and vapors emitted from the heat source to pass through the grilling grate assembly and out to the external environment, thus bypassing the food being cooked. The grilling grate assembly may be constructed of any material suitable for cooking food thereon, for example, stainless steel, aluminum, ceramic, metal alloy, etc.

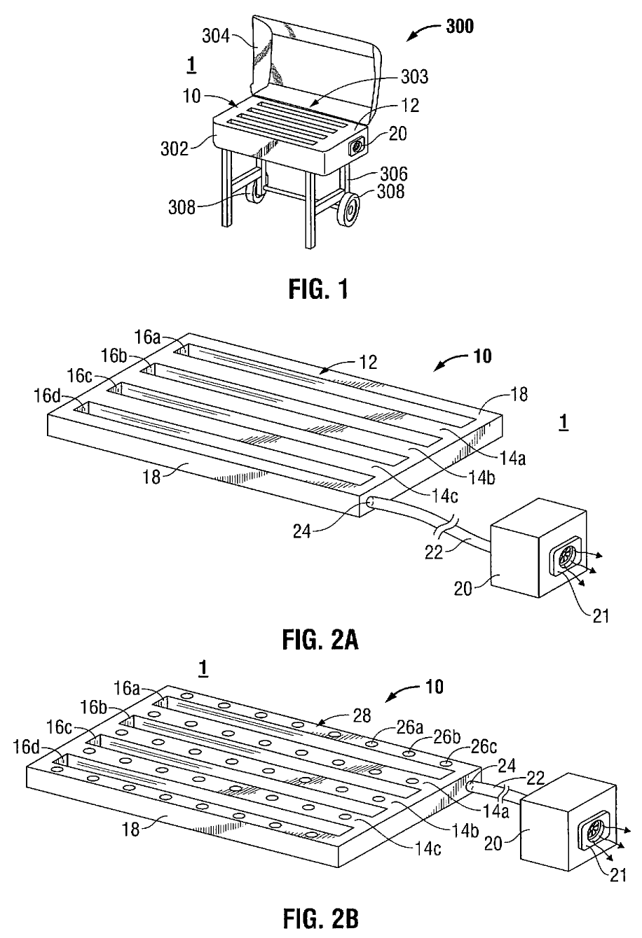

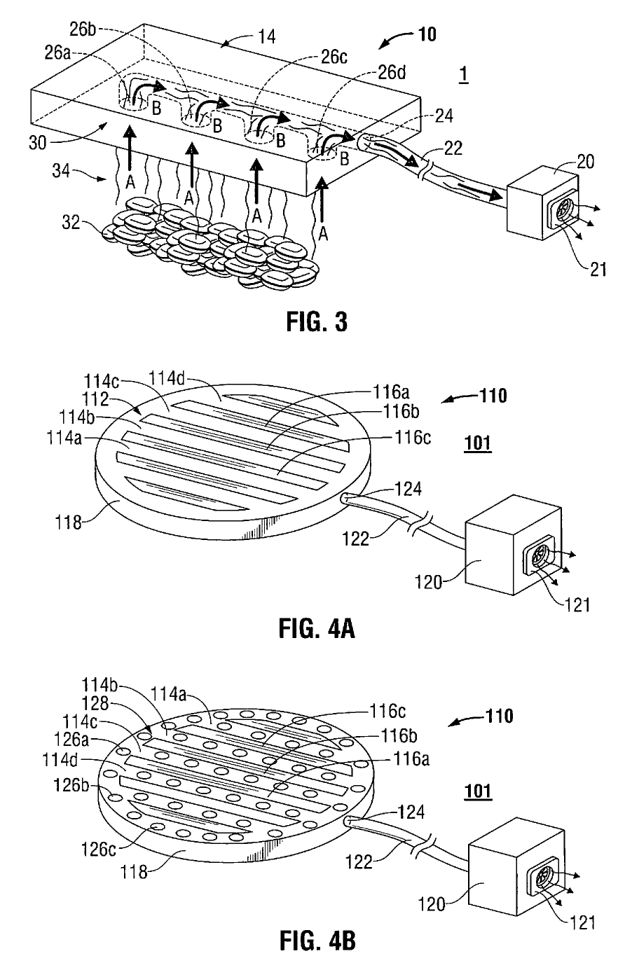

Referring now to FIG. 1, a barbecue grill assembly 300 is illustrated having a lower housing 302 and an upper housing 304. The lower housing 302 is configured to have a box-shape configuration, which includes a heat source 32, e.g., charcoal briquettes, (shown in FIG. 3) disposed on the bottom portion (not shown) of the lower housing 302. Additionally, an inner perimeter edge (not shown) of the lower housing 302 supports a grilling grate assembly 10 in accordance with the present disclosure. The grilling grate assembly 10 is configured to support food on a top surface 12. The upper housing 304 of the barbecue grill assembly 300 is shown in an open position and is configured to selectively cover the grilling grate assembly 10 in a closed position (not shown), while food is being cooked. When the upper housing 304 is in the closed position, the temperature increases between the top surface 12 and the inner cavity of the upper housing 304, which define a cooking space 303. The barbecue grilling assembly 300 is supported by a leg structure 306 having a plurality of wheels 308, thus allowing a user to transport the barbecue grill assembly 300.

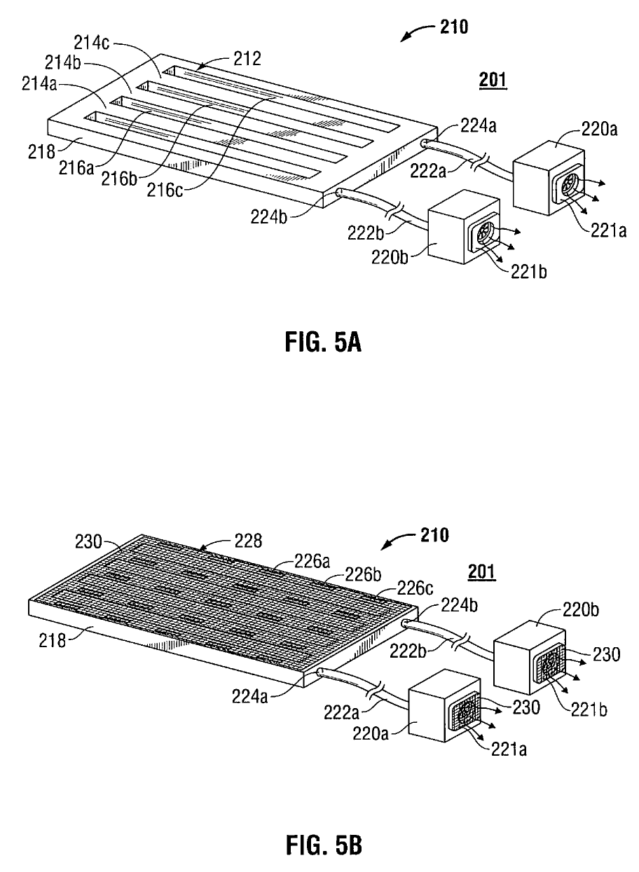

FIGS. 2A-2B illustrate the presently disclosed barbecue grilling grate assembly 1 including a grilling grate 10. The grilling grate 10 having a plurality of bars 14a-d each having a hollow space defining a channel 30 (shown in FIG. 3) therethrough. The plurality of grilling bars 14a-d are fluidly connected to a bordering bar 18. The grilling bars 14a-d, for example, may be constructed from hollow tubes that arc welded together to a bordering hollow tube that may have any suitable shape (e.g., rectangular, square, elliptical, etc.) in order to fit into the barbecue grilling assembly 300. (See FIGS. 4A-5B)

The grilling grate 10 further includes a top surface 12 and a bottom surface 28. FIG. 2A illustrates top surface 12, which is configured to accommodate food (e.g., vegetable, meats, fish, etc.) thereon, which in turn, may be cooked on the top surface 12. The top surface 12 of grilling grate 10 may be configured to have a smooth surface, textured surface, TEFLON coated surface, or any other suitable cooking surface. Grilling grate 10 also includes a plurality of inlet ports 26a-c and a plurality of channels 30, which are in fluid and gaseous communication with an outlet port 24, a tubular structure 22, and a smoke evacuation device 20. All of these components will be further discussed in detail below.

The grilling bars 14a-d are configured to be positioned parallel and equally spaced from each other, whereby the spaces define slits 16a-d. Slits 16a-d are configured in a way, such that heat energy from the heat source 32 rises up between the grilling bars 14a-d and through the slits 16a-d in order to cook the food placed on the top surface 12. Additionally, slits 16a-d are configured to allow the fluid and debris from the food to fall through the grilling grate assembly 1 to the bottom portion of the lower housing 302. Alternatively, the spacing and arrangement of the slits 16a-d may vary depending on the manufacturer's preference of the placement of grilling bars 14a-d. The grilling bars 14a-d may be welded, glued, soldered, or any other suitable attaching means to the bordering bar 18. Alternatively, grilling grate 10 may be constructed by a molding process, resulting in a one-piece design, thus requiring no attaching means.

Referring now to FIG. 2B, the plurality of inlet ports 26a-c are disposed on the bottom surface 18 of the grilling grate 10. The grilling grate 10 may include any amount of inlet ports 26. For brevity purposes, only inlet ports 26a-c will be described since all of the inlet ports of the present disclosure function in a similar manner. The inlet ports 26 are defined as openings disposed on the bottom surface 28 of the grilling grate 10 and are configured to allow smoke and vapors to enter into the plurality of channels 30.

It is envisioned that bordering bar 18 may be constructed with a thicker wall than the wall of the grilling bars. The thicker wall would assist in withstanding frequent positioning of the grilling grate assembly 1, while at the same time adding structural rigidity to the grilling grate assembly 1. The bordering bar 18 of the grilling grate 10 is supported on a plurality of supports (not shown) alongside the barbecue grill assembly 300.

Referring now to FIGS. 1 and 3, the barbecue grilling grate assembly 10 is positioned on the barbecue grill assembly 300 (shown in FIG. 1) and heat source 32 is selectively activated by a user. The heat source 32 (shown in FIG. 3), as mentioned above, may include barbecue briquettes, a beating element, gas jets, or any other suitable heat source. After the heat source 32 has been activated, the grilling grate assembly 10 heats to an ideal temperature for cooking, which allows for food to be placed atop the grilling surface for ideal cooking. While the food is being cooked atop the grilling grate 10, the plurality of inlet ports 26a-d, disposed on the bottom of the grilling grate 10, are configured to receive the smoke that rises from the heat source or any other part of the barbecue housing releasing smoke.

The smoke evacuation device 20, 120, and 220a and 220b, shown in FIGS. 1-5B, creates a vacuum, which in turn, evacuates (i.e. vacuums) the smoke and vapor 34 created by the heat source 32. A smoke evacuation device may be, for example, an exhaust fan mechanism 21, 121, and 221a and 221b or any other suitable smoke evacuation device. The smoke evacuation device may be either be attached to the grilling grate assembly or attached to the barbecue grilling assembly 300, as shown in FIG. 1. It is envisioned that the smoke evacuation device 20, 120, 220a and 220b may have an on/off switch and a variable speed switch, in order to allow a user to adjust the rate of smoke and vapor 34 to be evacuated. The outlet port 24, 124, 224a and 224b is fluidly connected to the smoke evacuation device by a tubular structure 22, 122, 222a and 222b. The tubular structure may be an industrial grade metal mesh hose, or any other suitable material.

As illustrated in FIG. 3, a user may selectively activate the smoke evacuation device 20 to vacuum the smoke and vapors 34 into the plurality of inlet ports 26a-d in a direction depicted by directional arrows “A”. The smoke 34 is then further vacuumed through the channels 30 and out to the outlet port 24 of the grilling grate assembly 10 in a direction depicted by directional arrows “B”. The outlet port 24 may be configured to be disposed in any suitable location on the grilling grate 10, for example, on the top surface, bottom surface or the side surface.

The vacuumed smoke and vapors 34 then travel through the tubular structure 22 and fan 21 out of the grilling grate assembly 10. Thus, allowing the harmful smoke and vapors emitted from the heat source to pass through the grilling grate assembly and out to an external environment, thus bypassing the food being cooked.

FIGS. 4A and 4B illustrate other embodiments of a grilling grate assembly 101 constructed in a radial shape. Grilling grate assembly 101 includes a grilling grate 110 having grilling bars 114 defining slits 116a-c, similarly to grilling grate assembly 10. Grilling grate 101 also includes inlet ports 126a-c, an outlet port 124, a tubular structure 122, and a smoke evacuation device 120, also similar to grilling grate assembly 10.

FIGS. 5A-5B illustrate a grilling grate assembly 201, similar to grilling grate assembly 1, having a plurality of outlet ports 224a and 224b, along with a plurality of tubular structures 222a and 222b and a plurality of smoke evacuation devices 220a and 220b. In embodiments, as shown in FIG. 5B, grilling grate 210 is shown having a bottom surface 228 including rectangular inlet ports. It is envisioned that the inlet ports may be any suitable shape to accommodate inlet of smoke to into the channel 30. FIG. 5B further illustrates grilling grate assembly 201 having filter element 230 disposed on the inlet ports 226a-c of grilling grate 210. Filter element 230 is configured to restrict, i.e., filter, any grease or debris contained within the smoke and vapors rising from the heat source. For example, filter device 230 prevents the channels of the grilling grate assembly 201 from clogging and/or being constricted with debris. In addition, smoke evacuation devices 220a and 220b also include filter elements 230 installed thereon. For example, the filter element 230 filters substantially all of the debris and/or smoke departing from the smoke evacuation devices 220a and 220b, thus maintaining a substantially clean and odorless external environment. The filter elements 230 may be constructed from any suitable material, for example, screens, fire-proof cloth, micro-fiber, etc.

Although the illustrative embodiments of the present disclosure have been described herein with reference to the accompanying drawings, it is to be understood that the disclosure is not limited to those precise embodiments, and that various other changes and modifications may be effect therein by one skilled in the art without departing from the scope or spirit of the disclosure.

1. A barbecue grilling grate assembly comprising:
a grilling grate including at least one grilling bar fluidly connected to at least one bordering bar, the grilling grate defining hollow channels therewithin to allow smoke from a heat source to pass therethrough, the grilling grate further including a top surface configured to allow food to be cooked atop and a bottom surface;
at least one inlet port disposed on the bottom surface of the grilling grate, the at least one inlet port configured to allow smoke from a heat source to enter therethrough into the hollow channels of the grilling grate; and
at least one outlet port disposed on the grilling grate, the at least one outlet port in fluid communication with a tubular structure and a smoke evacuation device, wherein the tubular structure and the smoke evacuation device are selectively attached to the at least one outlet port, the smoke evacuation device is configured to evacuate the smoke entering the grilling grate and to force the smoke to an external environment outside the grilling grate assembly.

2. The barbecue grilling grate assembly according to claim 1, wherein the grilling grate assembly is configured to be dimensioned by a group of shapes consisting rectangular, square, elliptical, and polygonal.

3. The barbecue grilling grate assembly according to claim 1, wherein the top surface of grilling grate is configured to be coated by a finishing technique selected from the group consisting of a smooth surface, a textured surface, and a TEFLON coated surface.

4. The barbecue grilling grate assembly according to claim 1, further comprising a plurality of grilling bars configured to be positioned parallel and equally spaced from each other, the spaces of the grilling bars defining slits.

5. The barbecue grilling grate assembly according to claim 1, wherein the at least one grilling bar is fluidly connected to the at least one bordering bar from an attaching technique selected from the group of consisting of welding, gluing, soldering, bonding, and crimping.

6. The barbecue grilling grate assembly according to claim 1, wherein the grilling grate assembly is constructed by a molding process.

7. The barbecue grilling grate assembly according to claim 1, wherein the at least one bordering bar is configured to have a thicker wall than the wall of the at least one grilling bar, the thicker wall adding structural rigidity to the grilling grate.

8. The barbecue grilling grate assembly according to claim 1, wherein the heat source is energized by a heating technique selected from the group consisting of barbecue briquettes, a heating element, and gas jets.

9. The barbecue grilling grate assembly according to claim 1, wherein the smoke evacuation device is an exhaust fan mechanism.

10. The barbecue grilling grate assembly according to claim 1, wherein the smoke evacuation device comprises an on/off switch.

11. The barbecue grilling grate assembly according to claim 1, wherein the smoke evacuation device comprises a variable speed switch to allow a user to adjust the rate of smoke and vapor to be evacuated.

12. The barbecue grilling grate assembly according to claim 1, further comprising at least one filter configured to cover the at least one inlet port of the bottom surface of the grilling grate.

13. The barbecue grilling grate assembly according to claim 1, wherein the inlet ports are configured to be dimensioned by a group of shapes consisting of a circular shape, a square shape, a rectangular shape, and a polygonal shape.

14. A barbecue grilling system comprising:
a housing having a heat source disposed within the housing, the housing configured and dimensioned to support a grilling grate assembly, the grilling grate assembly comprising:
a grilling grate having at least one grilling bar fluidly connected to at least one bordering bar, the grilling grate defining hollow channels therewithin to allow smoke from a heat source to pass therethrough, the grilling grate further having a top surface configured to allow food to be cooked atop and a bottom surface;
at least one inlet port disposed on the bottom surface of the grilling grate, the at least one inlet port configured to allow smoke from a heat source to enter therethrough into the hollow channels of the grilling grate; and
at least one outlet port disposed on the grilling grate, the at least one outlet port in fluid communication with a tubular structure and a smoke evacuation device, wherein the tubular structure and the smoke evacuation device are selectively attached to the at least one outlet port, the smoke evacuation device is configured to evacuate the smoke entering the grilling grate and to force the smoke to an external environment outside the grilling grate assembly.

15. The barbecue grilling system according to claim 14, wherein the housing includes an upper and lower housing, the lower housing having an inner perimeter edge, which is configured and dimensioned to support the grilling grate assembly.

16. The barbecue grilling system according to claim 15, wherein the upper housing is configured to be in an open position and a closed position, the closed position allowing a temperature to increase between the top surface and the inner cavity of the upper housing, the area between the top surface and the inner cavity defining a cooking space.

17. The barbecue grilling system according to claim 15, further comprising a leg structure to support the lower housing having a plurality of wheels to allow a user to transport the barbecue grilling system.

18. The barbecue grilling system according to claim 14, wherein the barbecue grilling system is configured to have a box-shape configuration.

19. The barbecue grilling system according to claim 14, wherein the top surface of grilling grate is coated by a finishing technique selected from the group consisting of a smooth surface, a textured surface, and a TEFLON coated surface.

20. The barbecue grilling system according to claim 14, wherein the smoke evacuation device is selectively attached to the grilling grate or selectively attached to the barbecue grilling system.
